(19) United States
(12) Patent Application Publication
(10) Pub. No.: US 2016/0266288 A1
(43) Pub. Date: Sep. 15, 2016

(54) Infrared-Blocking Nanocellulose Aerogel Windows

(71) Applicant: UT-Battelle, LLC, Oak Ridge, TN (US)

(72) Inventor: Soydan Ozcan, Oak Ridge, TN (US)

(21) Appl. No.: 15/064,974

(22) Filed: Mar. 9, 2016

Related U.S. Application Data
(60) Provisional application No. 62/132,178, filed on Mar. 12, 2015.

(51) Int. Cl. G02B 5/20; G02B 1/14; G02B 1/04; C08K 3/00

(52) U.S. Cl. CPC G02B 5/208; C08K 3/0041; G02B 1/14; G02B 1/04

(57) ABSTRACT

An optically transparent, infrared-blocking, composite material includes a matrix of transparent, cross-linked, cellulose aerogel nanofibrils having infrared blocking ceramic nanoparticles essentially homogenously dispersed therein. The composite material is both optically transparent and infrared-blocking, and can include an adherent, transparent protective layer disposed on one or both of two opposing surfaces.

### CROSS-REFERENCE TO RELATED APPLICATIONS

This application claims priority to U.S. Provisional Patent Application No. 62/132,178 filed on Mar. 12, 2015, the entire disclosure of which is incorporated herein in its entirety by reference.

Specifically referenced is U.S. patent application Ser. No. 14/551,460 filed on Nov. 24, 2014 by Soydan Ozcan, et al. entitled “Method of Making Controlled Morphology Metal-Oxides”, the entire disclosure of which is incorporated herein by reference.

### STATEMENT REGARDING FEDERALLY SPONSORED RESEARCH

The United States Government has rights in this invention pursuant to contract no. DE-AC05-00OR22725 between the United States Department of Energy and UT-Battelle, LLC.

### BACKGROUND OF THE INVENTION

Recent advances in nanotechnology have dramatically altered the opportunities and applications for cellulose. It is now well established that nanocellulosic structures with diameters of about 30 nm or less do not scatter visible light and, as a result, when cast into films, yield transparent materials. Current nanocellulose films, sheets, and plates typically possess a high optical transmittance of about 90%, a low coefficient of thermal expansion, high tensile strength, and low surface roughness. Nanocellulose materials having such excellent physical properties have been used in organic field transistors, conductive transparent paper, and light-emitting diodes.

Low-cost starting materials and energy-efficient fabrication processes are needed to achieve cost-effective insulation and visible light transparency goals of the US Department of Energy Building Technologies Office for transparent envelopes.

### BRIEF SUMMARY OF THE INVENTION

In accordance with one aspect of the present invention, the foregoing and other objects are achieved by an optically transparent, infrared-blocking, composite material includes a matrix of transparent, cross-linked, cellulose aerogel nanofibrils having infrared blocking ceramic nanoparticles essentially homogenously dispersed therein. The composite material is both optically transparent and infrared-blocking, and can include an adherent, transparent protective layer disposed on one or both of two opposing surfaces.

### BRIEF DESCRIPTION OF THE DRAWINGS

FIG. 1 is a schematic diagram showing cellulose aerogel nanofibrils (CNF).

FIG. 2 is a schematic diagram showing CNF with IR-blocking inorganic nanoparticles disposed thereon.

FIG. 3 is a schematic diagram showing cross-linked CNF with IR-blocking inorganic nanoparticles disposed thereon.

FIG. 4 is a schematic diagram showing compacted cross-linked CNF with IR-blocking inorganic nanoparticles disposed thereon.

FIG. 5 is a schematic diagram showing design and functionality of a planar, parallel transparent IR-blocking window.

FIG. 6 is a schematic diagram showing design and functionality of a nonplanar transparent IR-blocking window.

FIG. 7 is a schematic diagram showing design and functionality of a non-parallel transparent IR-blocking window.

FIG. 8 is a schematic diagram showing, at high magnification, a transparent protective polymer film, sheet, or plate containing CNF reinforcing strands.

For a better understanding of the present invention, together with other and further objects, advantages and capabilities thereof, reference is made to the following disclosure and appended claims in connection with the above-described drawings.

### DETAILED DESCRIPTION OF THE INVENTION

For the purposes of describing the present invention, optical transparency is defined as optical transmittance of at least 90%. Moreover, for the purposes of describing the present invention, infrared-blocking (IR-blocking) is defined as infrared transmittance of no more than 30%.

Cellulose aerogel nanofibrils (CNF) are nano-sized cellulose fibers (also called nanocellulose fibrils and/or strands) produced by bacteria or derived from plants. A cellulose-inorganic hybrid nanocomposite transparent window (can also be called a windowpane, glazing system, etc.) having an R-value up to about 9 is provided for a nominally standard thickness. The skilled artisan will recognize that higher R-values are attainable using materials having greater than standard thicknesses. Low-carbon-footprint, composite material is used to make high-performance functional windows having a reduced thermal transmission coefficient. CNF is a renewable feedstock that offers low cost, excellent reinforcement, and transparency.

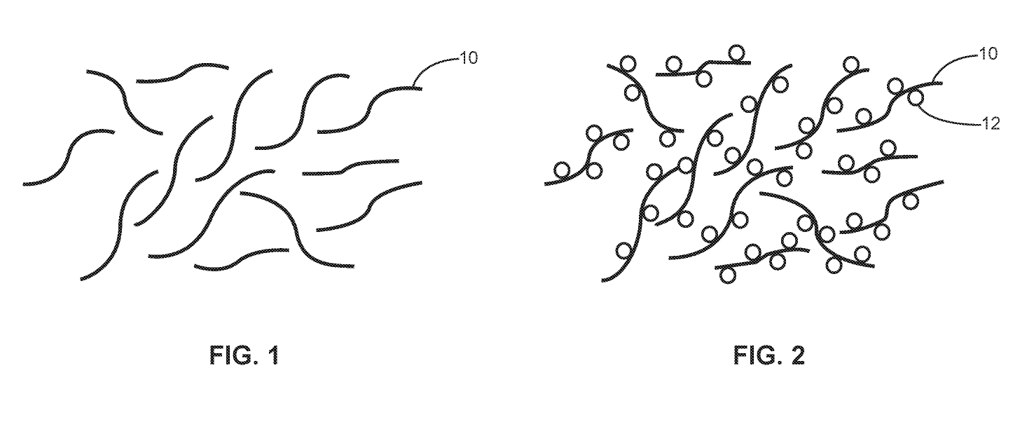

Referring to FIG. 1, for example, CNF 10, illustrated schematically, is a well-known material that is commercially available from sundry vendors; it is conventionally prepared by mechanical treatment, controlled acid hydrolysis, or enzymatic hydrolysis of cellulose fibers, which typically yields a strand nanostructure. CNF that is preferable for use in making transparent windows is generally characterized by an average length in the range of 200 to 400 nm and an average diameter in the range of 5 to 15 nm. CNF within the specified size range is essentially transparent to the visible light spectrum but does not block IR radiation. Depending on the specific source, CNF can have an average length of up to 1 μm and an average diameter of up to 40 nm. In cases where a certain plant develops longer and larger crystals, then CNF obtained therefrom can be commensurately larger. Transparency is likely variable in such cases, depending on the source; the skilled artisan will recognize that some experimentation may be helpful in determining the transparency and utility of CNF derived from a particular source.

CNF is modified with IR-reflecting ceramic nanomaterials such as, for example, anatase titania, antimony-doped tin oxide (ATO), indium-doped tin oxide (ITO), tantalum oxide, zinc oxide, and combinations of any of the foregoing, to form a transparent organic-inorganic hybrid nanocomposite material.

For example, IR-blocking inorganic nanoparticles can be evenly distributed in a freeze-dried nanocellulose aerogel matrix. The concentration of the nanoparticles should be sufficiently high to block IR but also sufficiently low to avoid deleterious effects on a desired level of transparency. The skilled artisan will recognize that optimal concentration of nanoparticles varies with thickness of the window, specific composition of the composite, and desired levels of transparency and IR-blocking characteristics.

IR-blocking inorganic nanoparticles can be spherical or non-spherical, fibrils, fibers, irregular-shaped, and can even be a partial or complete coating on the nanocellulose. Thus, an IR-blocking component can be added to the CNF to make an improved window.

Subsequently, the IR-light-reflective composites can be compacted to form resilient, thin-film or thick-film window core materials. Compaction creates resilient films at least partly because of the suitable mechanical properties of the individual transparent nanocellulose fibrils and the inter-fibrillary hydrogen bonding.

Referring to FIG. 2, for example, inorganic IR-blocking inorganic, particles 12, illustrated schematically, having a preferred average particle size in the range of 2 nm to 20 nm. Larger particles 12 having an average particle size in the range of up to 50 nm, 70 nm, 80 nm, or 90 nm may be feasible; the skilled artisan will recognize that some experimentation may be helpful in determining the feasibility thereof. Since it is known that the openings in CNF are generally less than 100 nm, particles larger than the openings are not likely to be feasible.

The particles 12 can be chemically bonded to CNF using a process developed at Oak Ridge National Laboratory and described hereinbelow. Moreover, the particles 12 can be synthesized on CNF.

Referring to U.S. patent application Ser. No. 14/551,460, incorporated hereinabove by reference, metal oxide nanostructures are recovered by pyrolyzing off the nanocellulose component. However, in the method used herein, the pyrolysis step is omitted; CNF metal ion complex gel is the intermediate product used to form a robust film for infrared protection. CNF template provides a robust skeleton that immobilizes the metal ions, especially through functionalized links. Thus, FIG. 2 illustrated schematically CNF 10 with IR-blocking inorganic nanoparticles 12 disposed thereon.

Functional end groups such as, for example, amine, acetyl acetonate, carboxylic acid, cyanide, etc. can be linked to CNF to enhance the immobilization of metal ions and/or metal oxide particles. For example, see Yuan Lu, et al., Improved mechanical properties of polylactide nanocomposites-reinforced with cellulose nanofibrils through interfacial engineering via amine-functionalization, Carbohydrate Polymers 131 (2015) 208-217. See also Yuan Lu, et al., A cellulose nanocrystal-based composite electrolyte with superior dimensional stability for alkaline fuel cell membranes, J. Mater. Chem. A, 2015, 3, 13350. Carboxylate, amine, and cyanide functional groups exhibit ligand-like behavior and form complexes with metal cations via dative bonding. The skilled artisan will recognize that preparation of metal ion immobilized CNF suspension can include at least one suspension stabilizer such as polyvinyl alcohol, phenolic polymers, polyalkylene oxide, polyacrylic acid, polyacrylic amide, etc.

As illustrated schematically in FIG. 2, essentially homogenous dispersion of nanoceramic particles 12 in the CNF 10 is critically important for optimal IR-blocking efficiency and transparency of the material. This is accomplished by using CNF as a template. CNF is transparent and will not scatter light as silica gels do. Moreover, CNF has extremely low thermal conductivity, which is about 5 mW/K, five times lower than that of air.

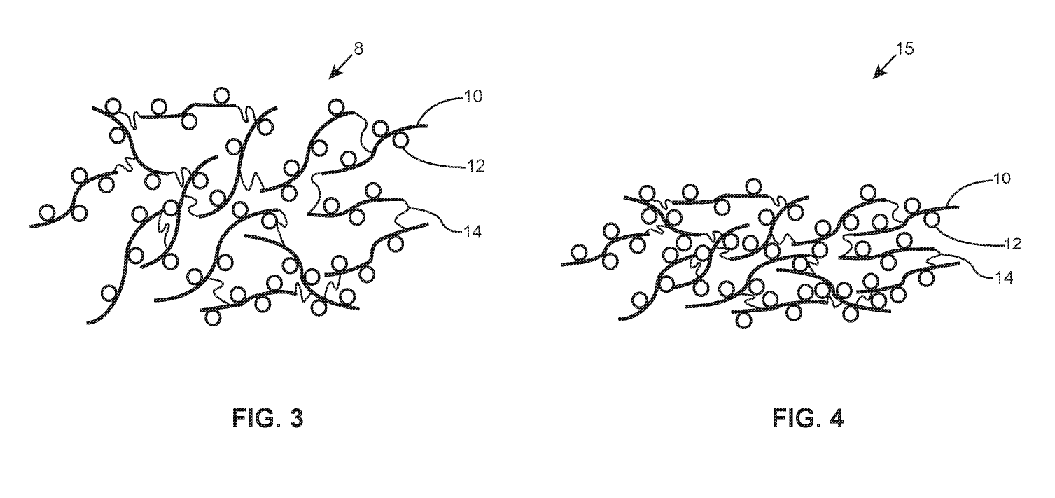

Subsequently, as illustrated schematically in FIG. 3, the CNF 10 is cross-linked 14 to improve the mechanical properties and stability of the composite window pane preform 8 from environmental effect. Crosslinking can be accomplished as described in U.S. patent application Ser. No. 14/551,460, incorporated hereinabove by reference. However, simple hydrogen bonding can provide sufficient cross-linking for some applications.

Subsequently, the cross-linked composite preform 8 is compacted into a composite material 15, as shown in FIG. 4, organic-inorganic composite durability and functionality thereof. The composite material 15 can be in the form of a thin-film or a thick-film on any suitable, transparent substrate, or it can be sufficiently robust to be formed into a sheet, plate, or other solid object.

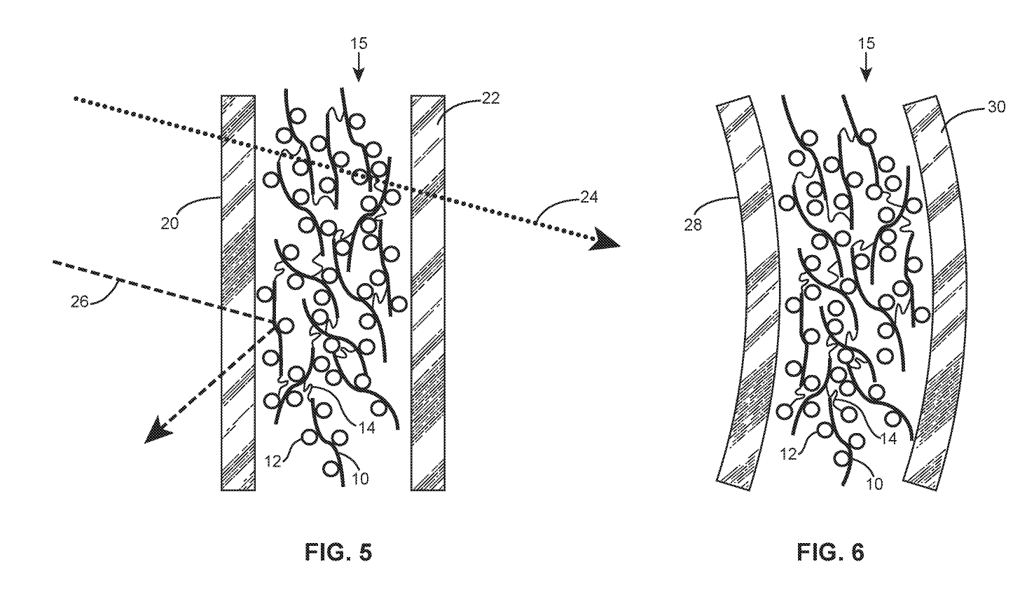

As illustrated schematically in FIG. 5 the optically transparent, IR-blocking, composite material 15 can be a core that is sandwiched between at least two, transparent, adherent, protective layers in contact therewith. A first protective layer 20 adheres to one surface of the core material, and a second protective layer 22 adheres to an opposing surface of the core material. The protective layer 20, 22 can be parallel to form, for example, a window pane. Arrow 24 shows optical transparency, while arrow 26 shows IR-blocking characteristic.

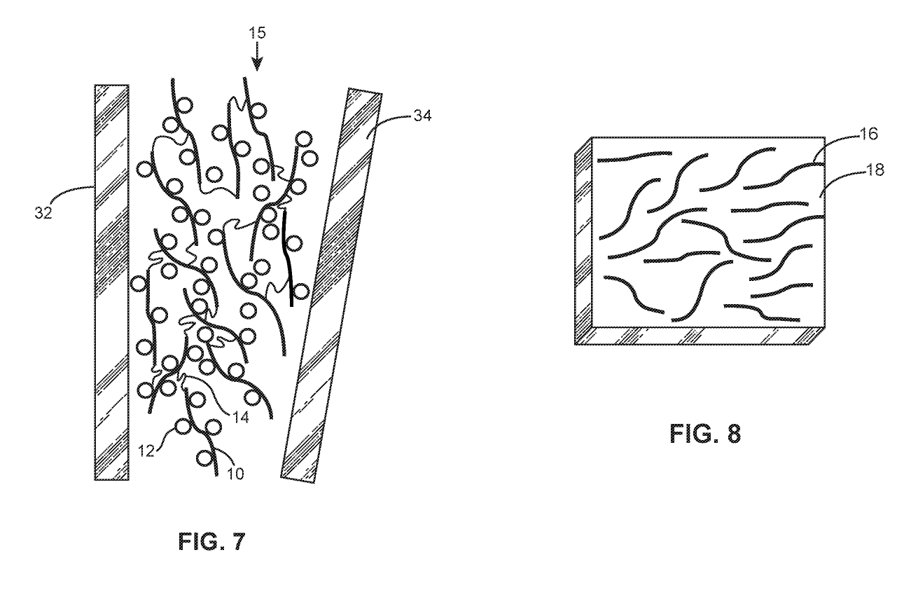

FIG. 6 shows the optically transparent, IR-blocking, composite material 15 sandwiched between nonplanar protective layers 28, 30. FIG. 7 shows the optically transparent, IR-blocking, composite material 15 sandwiched between non-parallel protective layers 32, 34. The skilled artisan will recognize that the optically transparent, IR-blocking, composite material can be sandwiched between irregularly shaped protective layers in contact therewith. Moreover, the protective layers can be of different shapes, and/or thicknesses. Moreover, the protective layers can be made of different materials.

The protective layers can comprise like materials or different materials, which can be preselected for suitability in particular environments. The protective layers can be films, applied sheets, or plates, and can be deposited, applied, or assembled. The protective layers can comprise any of various known transparent materials such as, for example, glass and/or a glazing polymer such as acrylic, polycarbonate, butyrate, polyethylene terephthalate, polystyrene, and combinations of any of the foregoing in, for example, a laminate structure. The protective layers can be of a suitable thickness for mechanical strength requirements.

Moreover, at least one of the protective layers can be formed from very low-thermal-conductivity composite material such as nanocellulose-reinforced polymer. FIG. 8 illustrates schematically, for example, a polymer matrix 16 that can comprise, for example, acrylic, polycarbonate, butyrate, polyethylene terephthalate, polystyrene, styrene, acrylonitrile, or a combination of any of the foregoing. CNF 18 provides mechanical reinforcement while maintaining transparency of the composite, and can be present in an amount in the range of 2 to 60 weight %, preferably in the range of 10 to 50 weight % of the composite. Thermal conductivity of such films can be about 0.1 W/(m·K). Such protective films are significantly lighter than glass, and do not shatter into sharp pieces when broken.

The unique materials design is effective at conserving room temperature by blocking IR light. Thus, it is possible to utilize the present invention to make sundry types of windows, lenses, sight glasses, and the like. The various schematic diagrams in the drawings show only a few examples of the sundry configurations that are possible.

While there has been shown and described what are at present considered to be examples of the invention, it will be obvious to those skilled in the art that various changes and modifications can be prepared therein without departing from the scope of the inventions defined by the appended claims.

What is claimed is:

1. An optically transparent, infrared-blocking, composite material comprising a matrix of transparent, cross-linked, cellulose aerogel nanofibrils having infrared blocking ceramic nanoparticles essentially homogenously dispersed therein, said material being both optically transparent and infrared-blocking.

2. An optically transparent, infrared-blocking, composite material in accordance with claim 1 wherein said cellulose aerogel nanofibrils have an average length of up to 1 μm and an average diameter of up to 40 nm.

3. An optically transparent, infrared-blocking, composite material in accordance with claim 2 wherein said cellulose aerogel nanofibrils have an average length in the range of 200 to 400 nm and an average diameter in the range of 5 to 15 nm.

4. An optically transparent, infrared-blocking, composite material in accordance with claim 1 wherein said infrared blocking ceramic nanoparticles comprise at least one material selected from the group consisting anatase titania, antimony-doped tin oxide, indium-doped tin oxide, tantalum oxide, zinc oxide, and combinations of any of the foregoing.

5. An optically transparent, infrared-blocking, composite material in accordance with claim 1 wherein said infrared blocking ceramic nanoparticles are chemically bonded to said cellulose aerogel nanofibrils.

6. An optically transparent, infrared-blocking, composite material in accordance with claim 1 wherein said infrared blocking ceramic nanoparticles have average particle size of up to 90 nm.

7. An optically transparent, infrared-blocking, composite material in accordance with claim 6 wherein said infrared blocking ceramic nanoparticles have average particle size of up to 50 nm.

8. An optically transparent, infrared-blocking, composite material in accordance with claim 7 wherein said infrared blocking ceramic nanoparticles have average particle size in the range of 2 nm to 20 nm.

9. An optically transparent, infrared-blocking, composite material in accordance with claim 1 wherein said material defines a surface, said surface being in contact with an adherent, transparent protective layer.

10. An optically transparent, infrared-blocking, composite material in accordance with claim 9 wherein said adherent, transparent protective layer comprises at least one material selected from the group consisting of glass, acrylic, polycarbonate, butyrate, polyethylene terephthalate, polystyrene, and combinations of any of the foregoing.

11. An optically transparent, infrared-blocking, composite material in accordance with claim 9 wherein said surface is a first surface, and wherein said material further defines a second surface, said second surface being in contact with a second adherent, transparent protective layer.

12. An optically transparent, infrared-blocking, composite material in accordance with claim 11 wherein said second adherent, transparent protective layer comprises at least one material selected from the group consisting of glass, acrylic, polycarbonate, butyrate, polyethylene terephthalate, polystyrene, and combinations of any of the foregoing.

13. An optically transparent, infrared-blocking window comprising:
a. an optically transparent, infrared-blocking, composite core material comprising an optically transparent, infrared-blocking, composite material comprising a matrix of transparent, cross-linked, cellulose aerogel nanofibrils having infrared blocking ceramic nanoparticles essentially homogenously dispersed therein, said material being both optically transparent and infrared-blocking, said core material defining at least two opposing surfaces;
b. a first adherent, transparent protective layer disposed on one of said opposing surfaces; and
c. a second adherent, transparent protective layer disposed on the other of said opposing surfaces.

14. An optically transparent, infrared-blocking window in accordance with claim 13 wherein said cellulose aerogel nanofibrils have an average length of up to 1 μm and an average diameter of up to 40 nm.

15. An optically transparent, infrared-blocking window in accordance with claim 14 wherein said cellulose aerogel nanofibrils have an average length in the range of 200 to 400 nm and an average diameter in the range of 5 to 15 nm.

16. An optically transparent, infrared-blocking window in accordance with claim 13 wherein said infrared blocking ceramic nanoparticles comprise at least one material selected from the group consisting anatase titania, antimony-doped tin oxide, indium-doped tin oxide, tantalum oxide, zinc oxide, and combinations of any of the foregoing.

17. An optically transparent, infrared-blocking window in accordance with claim 13 wherein said infrared blocking ceramic nanoparticles are chemically bonded to said cellulose aerogel nanofibrils.

18. An optically transparent, infrared-blocking window in accordance with claim 13 wherein said infrared blocking ceramic nanoparticles have average particle size of up to 90 nm.

19. An optically transparent, infrared-blocking, composite material in accordance with claim 18 wherein said infrared blocking ceramic nanoparticles have an average particle size of up to 50 nm.

20. An optically transparent, infrared-blocking window in accordance with claim 19 wherein said infrared blocking ceramic nanoparticles have an average particle size in the range of 2 nm to 20 nm.

21. An optically transparent, infrared-blocking window in accordance with claim 13 wherein said first adherent, transparent protective layer comprises at least one material selected from the group consisting of glass, acrylic, polycarbonate, butyrate, polyethylene terephthalate, polystyrene, and combinations of any of the foregoing.

22. An optically transparent, infrared-blocking window in accordance with claim 13 wherein said second adherent, transparent protective layer comprises at least one material selected from the group consisting of glass, acrylic, polycarbonate, butyrate, polyethylene terephthalate, polystyrene, and combinations of any of the foregoing.

23. An optically transparent, infrared-blocking window in accordance with claim 13 wherein said first and second adherent, transparent protective layers are essentially parallel.

24. An optically transparent, infrared-blocking window in accordance with claim 13 wherein said first and second adherent, transparent protective layers are essentially non-parallel.

25. An optically transparent, infrared-blocking window in accordance with claim 13 wherein at least one of said first and second adherent, transparent protective layers is essentially planar.

26. An optically transparent, infrared-blocking window in accordance with claim 13 wherein at least one of said first and second adherent, transparent protective layers is essentially non-planar.
